(19) United States
(12) Patent Application Publication
(10) Pub. No.: US 2004/0089595 A1
(43) Pub. Date: May 13, 2004

(54) Flotation machine

(76) Inventor: Christian Kujawa, Highlands Ranch, CO (US)

Correspondence Address: MORGAN & FINNEGAN, L.L.P., 345 Park Avenue, New York, NY, 10154-0053, US

(21) Appl. No.: 10/293,404

(22) Filed: Nov. 13, 2002

(51) Int. Cl. C02F 1/24

(52) U.S. Cl. 210/221.2

(57) ABSTRACT

The invention relates to a flotation machine (1) which at least contains a flotation cell (2) having a means for feeding slurry in the flotation cell, gas dispersion mechanism (6) for feeding gas into the slurry and producing froth and aerated slurry (3), a means for removing froth (4) from the flotation cell and a means for removing tailings from the flotation cell, wherein there is arranged at least one separation element (7) in order to separate the upward going flow (8) and the returning flow (9) from each other in the cell (2).

The invention relates to a flotation machine to be used in flotation of slurry for separation valuable components from tailings, when there is arranged at least one separation element in order to separate the upward going flow and the returning flow from each other in the flotation cell.

A froth flotation machine for recovering valuable mineral particles normally comprises a flotation cell in the form of a tank having an inlet in the cell wall for feeding slurry to be floated as well as an outlet for tailings in the lower part of the cell. Flotation cells may be single mixing vessels, in series or in parallel. They may be either rectangular or cylindrical in shape, in horizontal or upright position. Gas is routed through either the hollow mixing shaft or by means of another supply mechanism to the gas dispersion mechanism. The gas dispersion mechanism causes a powerful suction as it rotates, which sucks the gas into the rotor space. In the gas dispersion mechanism space the slurry is mixed with the gas as the gas is dispersed into small bubbles. Usually stationary baffles are installed around the gas dispersion mechanism, which promotes further gas dispersion and attenuates the rotation of the slurry. Valuable hydrophobic material stuck to the gas bubbles rise from the gas dispersion mechanism to the surface of the cell and into the froth layer and from there out of the cell into the froth launders.

Nowadays it is becoming increasingly common to use upright cells, which are also cylindrical and normally flat-bottomed. One problem with flotation cells is sanding, i.e. solid matter builds up on the bottom of the cell in an immovable layer. This is usually due to a too small or ineffective rotor, as in such a case the mixing zone of the rotor does not extend far enough. Another common difficulty is that the mineral particles already attached to the gas bubbles cannot be removed from the flotation cell, because the flows forming in the cell and particularly at its surface and upper section are wrongly oriented or too weak i.e. they are not able to move the floated gas bubbles out of the cell.

A very common type of flotation mechanism consists of a rotating rotor with fixed stator blades around the rotor. Gas is fed near the rotor for example through the rotor shaft. As a result of flotation, valuable hydrophobic material attach to gas bubbles and accumulate in froth in the upper part of the flotation cell and are discharged to a launder attached to the cell. Tailings of the slurry are directed to the next separation step.

It is also known before a flotation machine, a rotor of which has a plurality of vertical oriented plates, which form the pumping chambers. Air is pumped to each chamber via a vertical downcomer, which also incorporates and supports a horizontal shroud directly above the rotor. This shroud also supports the vertical stator blades. While the slurry flow entering the rotor is initially deflected upwards as it exits the rotor pumping slots it is deflected horizontally by the overhung shroud and is pumped radially outwards through the stator blades.

During the dispersion of gas by mechanical agitation, which creates negative pressure zone at the intake and positive pressure zone at the discharge, it is possible that the gas short-circuits from the positive pressure zone back to the negative pressure zone. This phenomenon is desirable during normal flotation practice but it can become excessive and counter productive in the case of high viscosity pulps. The re-circulation effect of gas into the lower pressure zone in the cell could be a problem with liquids either of high viscosity or heavy particle concentrations. Unnecessary circulation of dispersed gas also reduces the efficiency and output of the gas dispersion device.

The object of the present invention is to eliminate drawbacks of the prior art and to achieve a better flotation machine and more efficient flotation process.

The essential features of the invention are enlisted in the appended claims.

The invention concerns a flotation machine, which at least contains a flotation cell having a means for feeding slurry in the flotation cell, a gas dispersion mechanism for feeding gas into the slurry and producing froth and aerated slurry, a means for removing froth from the flotation cell and a means for removing tailings from the flotation cell, when there is arranged at least one separation element in order to separate the upward going flow and the returning flow from each other in the cell. When using the separation element of the invention the gas-rich upward going aerated slurry flow is separated from the gas-less returning de-aerated slurry flow. It achieves a natural pumping effect in the flotation machine and therefore leads to increased output rate from the flotation machine. It is highly beneficial in large flotation cells when the concentration particles need to travel long distances. It is also highly beneficial when heavy or coarse particles have to be recovered. Also it is highly beneficial when particles with poor gas bubble attachment characteristics have to be floated. According to the invention the separation element is located at the interface between aerated slurry and de-aerated slurry. The separation element prevents the short-circuiting of gas and aerated slurry to go back to the intake zone, thus eliminating inefficiency in the flotation machine. The separation element is arranged to cover at least part of the slurry area. The separation element is arranged to circle at least part of the gas dispersion mechanism. According to one application of invention the separation element is arranged to circle the whole gas dispersion mechanism. Then all gas dispersed into the cell is being routed upwards. The separation element is symmetrically oriented in respect of the gas dispersion mechanism. Also the separation element is upward oriented in the cell. Then it advantageously guides the upward going flow into upper part of the cell. According to one application of the invention the separation element consists of at least one element. According to one application of invention the separation element approaches the gas dispersion mechanism in the neutral pressure zone between the low pressure intake zone and the high pressure output zone of the gas dispersion mechanism. According to one application of the invention the separation element is attached into the gas dispersion mechanism. The upper part of the separation element is located in the vicinity of the froth surface. The up-ward flow naturally moves the froth advantageously towards the froth removal launder. The separation element of the invention advantageously results in much higher flotation rates, which reduces the size of the flotation machine compared to the usual cell designs. The separation of the outward and returning flow delineates the flows and prevents the unwanted interferencies between streams trying to find their paths. Also the up-ward flow moving into an expanding volume facilitates the separation of the froth from the slurry.

The invention is described further by means of the attached drawing;

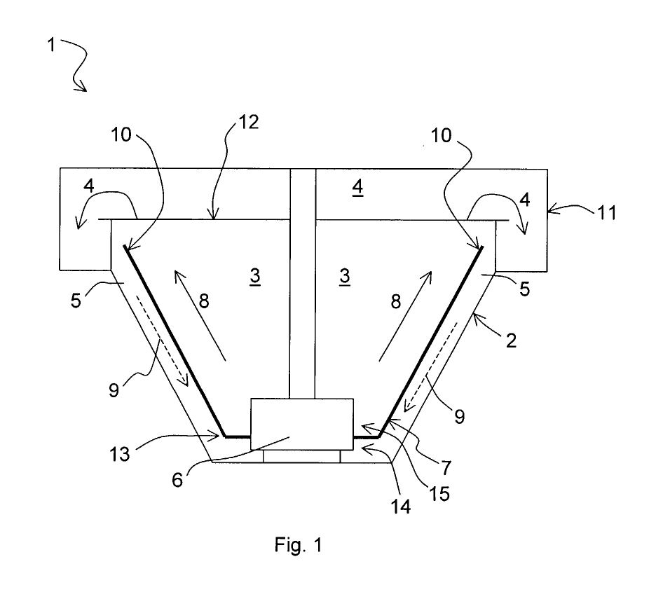

FIG. 1 Flotation machine

FIG. 1 shows a flotation machine 1, which at least contains a flotation cell 2 having a means for feeding slurry in the flotation cell, an gas dispersion mechanism 6 for feeding gas into the slurry and producing froth 4 and aerated slurry 3, a means for removing froth 4 from the flotation cell 2 and a means for removing tailings from the flotation cell. There is arranged at least one separation element 7 in order to separate the upward going flow 8 and the returning flow 9 from each other in the cell. The separation element 7 is right up in the upper zone of the flotation machine 1 to effectively separate the gas-rich upward going aerated slurry flow from the gas-less returning de-aerated slurry flow. The separation element 7 is located at the interface between the de-aerated slurry 5 and aerated slurry 3. According to this example it is attached into the gas dispersion mechanism 6 and the separation element circles the whole gas dispersion mechanism symmetrically approaching the gas dispersion mechanism at the neutral pressure zone 13 between the low pressure intake zone 14 and the high pressure output zone 15 of the gas dispersion mechanism. The separation element according to this example of invention consists of one element. The separation element achieves a natural circulation effect in the flotation machine and different levels in the cell, as the level on the gas rich-zone is higher than the level in the gas-less region. This natural difference in levels assists the recirculatory flow created by the gas dispersion mechanism. By using the separation element the upward flow promotes the flow of the bubble-particle aggregates to the top of the cell. The upper part 10 of the separation element 7 is located in the vicinity of the froth surface 12. By promoting the upward flow effect in the cell also the froth removal towards cell launder 11 is being accelerated.

1. Flotation machine (1) which at least contains a flotation cell (2) having a means for feeding slurry in the flotation cell, a gas dispersion mechanism (6) for feeding gas into the slurry and producing froth and aerated slurry (3), a means for removing froth (4) from the flotation cell and a means for removing tailings from the flotation cell, wherein there is arranged at least one separation element (7) in order to separate the upward going flow (8) and the returning flow (9) from each other in the cell (2).

2. Flotation machine according to the claim 1, wherein the separation element (7) is located at the interface between the de-aerated slurry (5) and aerated slurry (3).

3. Flotation machine according to the claim 1 or 2, wherein the separation element (7) is arranged to cover at least part of the slurry area.

4. Flotation machine according to the claim 1, 2 or 3, wherein the separation element (7) is arranged to circle at least part of the gas dispersion mechanism (6).

5. Flotation machine according to the claim 1, 2 or 3, wherein the separation element (7) is arranged to circle the whole gas dispersion mechanism (6).

6. Flotation machine according to any of the preceding claims, wherein the separation element (7) is symmetrically oriented in respect of the gas dispersion mechanism (6).

7. Flotation machine according to any of the preceding claims, wherein the separation element (7) is upward oriented in the cell (2).

8. Flotation machine according to any of the preceding claims, wherein the separation element (7) consists of at least one element.

9. Flotation machine according to any of the preceding claims, wherein the separation element (7) approaches the gas dispersion mechanism (6) in the neutral pressure zone (13) between the low pressure intake zone (14) and the high pressure output zone (15) of the gas dispersion mechanism.

10. Flotation machine according to any of the preceding claims, wherein the separation element (7) is attached into the gas dispersion mechanism (6).

11. Flotation machine according to any of the preceding claims, wherein the upper part (10) of the separation element (7) is located in the vicinity of the froth surface (12).
